(19) United States
(12) Patent Application Publication
(10) Pub. No.: US 2009/0030621 A1
(43) Pub. Date: Jan. 29, 2009

(54) JIG ASSEMBLY FOR MEASURING PERFORMANCE OF DOOR OF VEHICLE

(76) Inventor: Sungcheul Ahn, Hwaseong-si (KR)

Correspondence Address: SUNGCHEUL AHN, 772-1, JANGDEOK-DONG, HWASEONG-SI, GYEONGGI-DO, 445-130, KR

(21) Appl. No.: 11/956,161

(22) Filed: Dec. 13, 2007

(30) Foreign Application Priority Data
Jul. 26, 2007 (KR) 10-2007-0075038

(51) Int. Cl. G01L 5/22

(52) U.S. Cl. 702/41; 702/81; 73/856

(57) ABSTRACT

A jig assembly for measuring performance aspects of a door of a vehicle. A shifting member includes guide rails and motors, the motors controlled by a controller to move the guide rails. The shifting member is configured such that one of several removable jigs can be connected thereto. Each jig cooperates with the controller to measure a specific performance aspect of the door.

### CROSS-REFERENCE TO RELATED APPLICATIONS

The present application is based on, and claims priority from, Korean Application Serial Number 10-2007-0075038, filed on Jul. 26, 2007, the disclosure of which is hereby incorporated by reference herein in its entirety.

### FIELD OF THE INVENTION

The present invention relates to an automated jig assembly for measuring performances of a door of a vehicle.

### BACKGROUND OF THE INVENTION

Vehicle doors are evaluated in terms of initial operation, response of opening/closing, the operation of an outside door handle, and the closing force of the weather strip on the door. These factors are usually evaluated manually by an operator with a push-pull gauge while he/she opens and closes the door. This is inaccurate and unreliable, and varies depending on the operator. The evaluation is therefore repeated several times to obtain more accurate data, which is time consuming.

### SUMMARY OF THE INVENTION

A jig assembly for measuring performance aspects of a door of a vehicle. A shifting member includes guide rails and motors, the motors controlled by a controller to move the guide rails. The shifting member is configured such that one of several removable jigs can be connected thereto. Each jig cooperates with the controller to measure a specific performance aspect of the door.

The assembly may also include a movable frame mounted to the shifting member, a load cell attached to the movable frame for measuring a load applied to the door, a shaft extending from the load cell, and a flexible shaft connected to the shaft and configured for the jigs to be connected thereto.

The jigs may be a jig for measuring operation of the door, a jig for measuring opening and closing of the door, a jig for measuring opening and closing of a handle of the door, and a jig for measuring closing force of the door.

A vacuum source may be provided to supply negative pressure to the jig, to attach the jig to the door.

The jig for measuring opening and closing of the door may include a door handle lock to lock the handle.

The jig for measuring opening and closing of the handle may include a rotary connection end that is combined to the shifting member, and a door handle locking body that is hinged to the rotary connection end and attachable to the handle.

The jig for measuring the closing force of the door may include a rotatable bearing connection end that is connected to the load cell; and a door contact end at an end of the bearing connection end, configured to contact the door.

The bearing connection end may be rotatable by approximately 60°.

The door contact end may be covered in urethane.

### BRIEF DESCRIPTION OF THE DRAWINGS

For better understanding of the nature and objects of the present invention, reference should be made to the following detailed description with the accompanying drawings, in which:

FIG. 1 shows a jig assembly according to an embodiment of the invention;

FIG. 2 shows a measuring device for the response of opening/closing of a door in the jig assembly of FIG. 1;

FIG. 3 shows the operation of the measuring device of FIG. 2;

FIG. 4 shows a measuring device for the initial operation of a door in the jig assembly of FIG. 1;

FIG. 5 shows the operation of the measuring device of FIG. 4;

FIG. 6 shows a measuring device for an outside handle of a door in the jig assembly of FIG. 1;

FIG. 7 shows a measuring device for closing force of a door in the jig assembly FIG. 1; and

FIG. 8 shows the operation of the measuring device of FIG. 7.

### DETAILED DESCRIPTION OF THE PREFERRED EMBODIMENTS

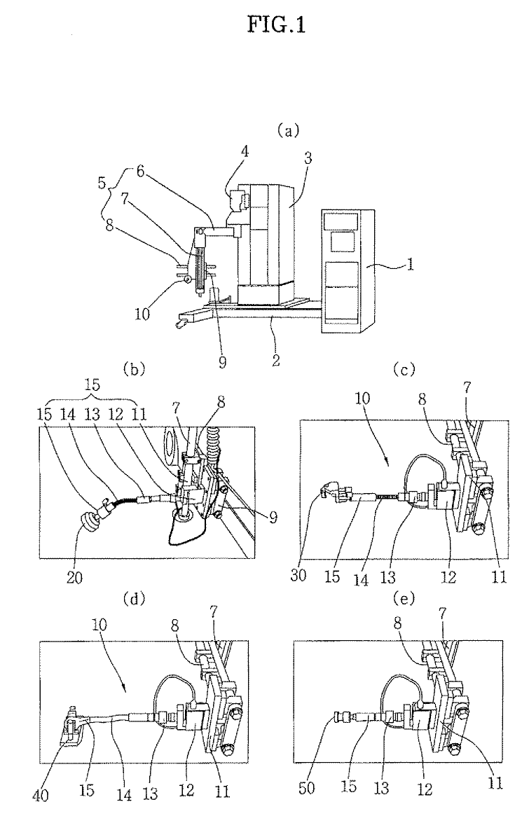

Referring to FIG. 1, a jig assembly for measuring performance of a door of a vehicle includes a controller 1 that generates control information and analyzes feed-backed measured information a driving unit for measuring that makes motions for measuring the performance of the door using a movable control box 2 connected to controller 1, and a jig unit 10 that is disposed at the end of the driving unit for measuring the performance while being in contact with the door.

Control box 2 is movable along a guide rail 3.

The driving unit for measuring of the jig assembly includes an upper driving motor 4 that is driven by movable control box 2, a shifting member 5 that is horizontally shifted by rotational force of upper driving motor 4, and a lower driving motor 9 that is disposed at the lower end of shifting member 5 and driven by movable control box 2.

The upper driving motor 4 moves the shifting member 5 forward and backward, and the lower driving motor 9 controls the movement of jig unit 10 to measure various aspects of door D). Accordingly, motion converting mechanisms are provided to convert the rotational forces of motors 4 and 9 into forward/backward motion and rotation. These mechanisms can be provided by a person of ordinary skill in the art based on the teachings herein.

Shifting member 5 includes an upper guide rail 6, a vertical connecting frame 7 that is moves horizontally along upper guide rail 6, and a lower guide rail 8 under vertical connecting frame 7 to guide the horizontal movement of vertical connecting frame 7.

Jig unit 10 includes a movable frame 11 disposed at the lower end of vertical connecting frame 7 of shifting, member 5, a load cell 12 that is connected to movable frame 11, and sets and measures the load applied in measuring the performances of a door, a shaft 13 that extends from load cell 12, a flexible shaft 14 that is connected to shaft 13 and bends to change the direction of the force applied to door D. One of several removable jigs is connected to a measurement jig connection end 15 of deformable shaft 14. Each jig actuates door D to measure one specific aspect of door D.

Further, the jigs measure a variety of items for door D, such as the initial operation, the response of opening/closing, the operation of an outside door handle, and the closing force.

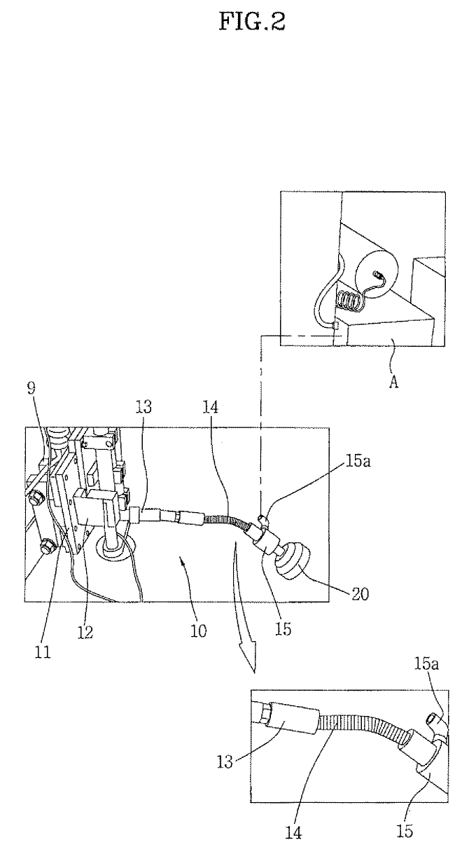

One of the jigs is a jig 20 that measures the initial operation of a door. As shown in FIG. 2, jig 20 is a plate that is mounted to the measurement jig connection end 15 of jig unit 10 and attached to door D. A vacuum power source A supplies negative pressure to the plate 20, and is connected to a pipe connection end 15a at measurement jig connection end 15.

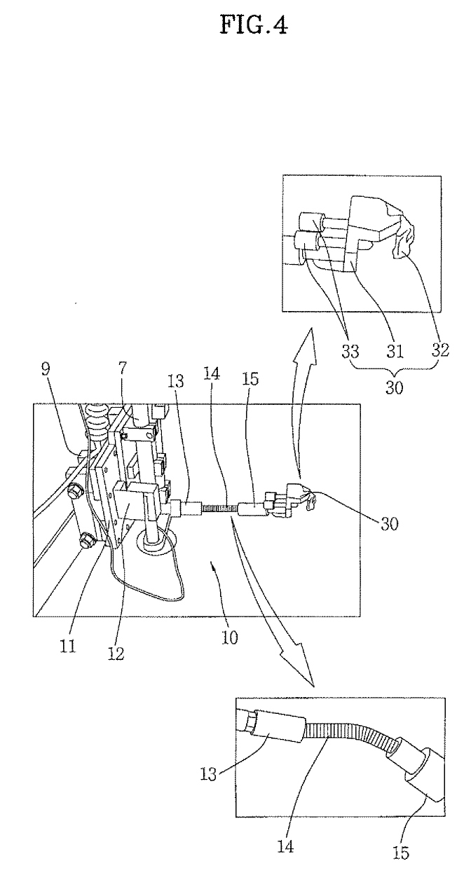

Further, a door opening/closing jig 30 measures the response of opening/closing of door D, as shown in FIG. 4. Jig 30 can be mounted to the measurement jig connection end 15 of jig unit 10 and attached to an outside handle of a door DH of door D.

Door opening/closing jig 30 has a connecting body 31 attachable to measurement jig connection end 15, a door handle lock 32 at the end of connecting body 31 to lock outside door handle DH, and door handle fixing ends 33 fastened to connecting body 31 to fix outside door handle DH to door handle lock 32.

Door handle fixing ends 33 are threaded and attached to threads on connecting body 31.

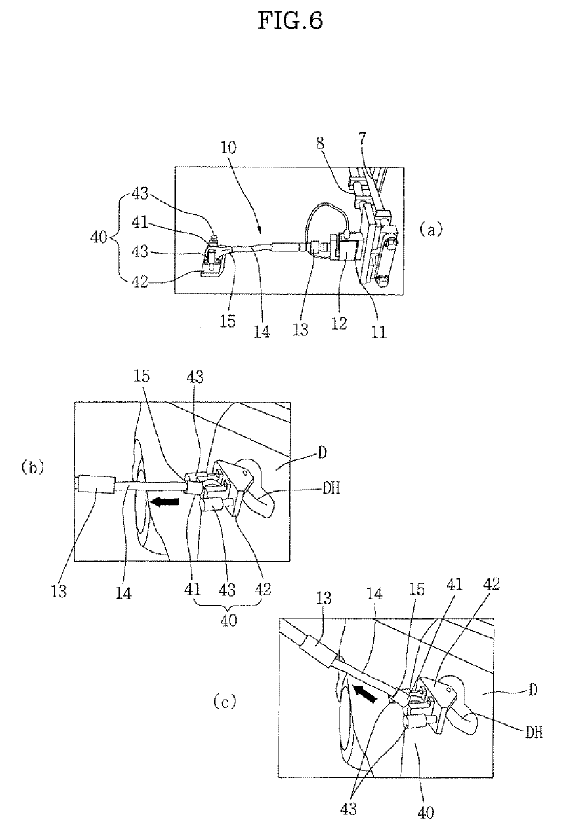

Further, a door handle opening/closing jig 40 that measures the operation of an outside handle of a door, as shown in FIG. 6, is mountable to measurement jig connection end 15 of jig unit 10 and holds and operates outside door handle DH of door D.

Door handle opening/closing jig 40 has a rotary connection end 41 connected to measurement jig connection end 15, a door handle locking body 42 hinged to rotary connection end 41 to adjust the operation angle when outside door handle DH is operated, and door handle fixing ends 43 fastened to door handle locking body 42 and movable to contact outside door handle DH.

Door handle fixing ends 43 are threaded and attached to threads on door handle locking body 42.

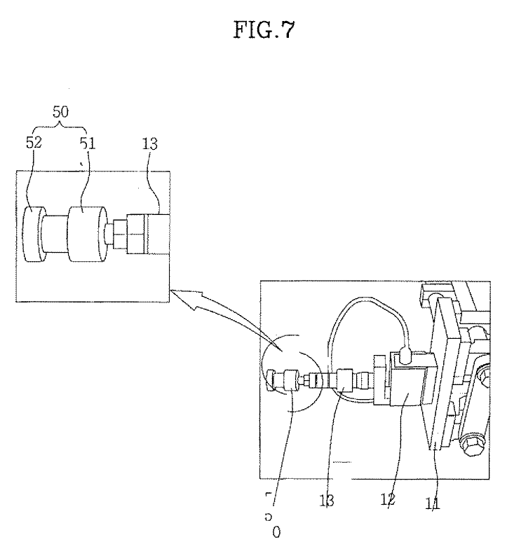

Further, as shown in FIG. 7, jig 50 for measuring closing force of a door is fastened to extending shaft 13 connected to load cell 12, and has a bearing connection end 51 freely rotating through a bearing provided inside and a door contact end 52 contacting door D at the end of bearing connection end 51.

Door contact end 52 is covered with a urethane material to protect the surface of door D.

The operation of a jig assembly for measuring performances of a door of a vehicle according to an embodiment of the invention is described hereafter in detail with reference to the accompanying drawings.

The jig assembly uses several separate jigs, depending on the items to be measured, and the controller 1 measures the items.

As shown in FIG. 1, measuring of door D is controlled by controller 1 that generates control information and analyzes feed-backed measurement information. Measuring of door D is achieved by the motors controlled by controller 1 and the driving unit.

As for the initial operation of the measuring items for door D, as controller 1 operates according to each of control items and processes for measuring the initial operation of the door, upper driving motor 4 and lower driving motor 9 are driven by control box 2 connected to controller 1 and the initial operation of the door is measured by controlling motors 4 and 9.

As lower driving motor 9 is driven, as shown in FIG. 2, measurement jig connection end 15 connects load cell 12 to jig 20 for measuring the initial operation of the door.

Vacuum power source A is connected to measurement jig connection end 15 through pipe connection end 15a to provide a negative pressure to jig 20 after contacting the plate to the outer panel of door D.

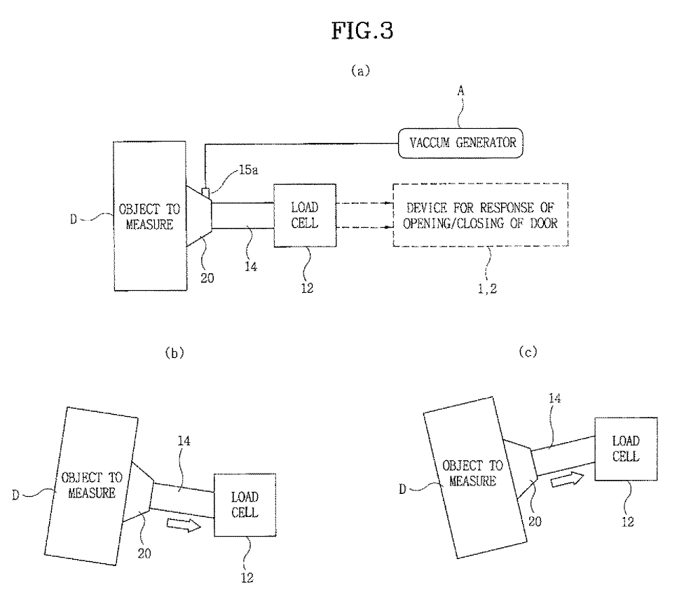

After the plate is fixed to door D, controller 1 drives upper and lower driving motors 4 and 9, and as shown in FIGS. 3B and 3C, door D is pulled up/down by the plate.

Load cell 12 measures changes in the door opening/closing force applied by jig 20 and controller 1 analyzes the changes in the force in a manner that can be designed by a person of ordinary skill in the art based on the teachings herein.

In opening/closing door D, abnormal displacement through the hinge of door D is compensated by deformable shaft 14, either mechanically or by calculation through a program for measurement signals.

The response of opening/closing of door D is measured by a separate jig 30, that is, as shown in FIG. 4, jig 20 is removed and then jig 30 is attached to measurement jig connection end 15.

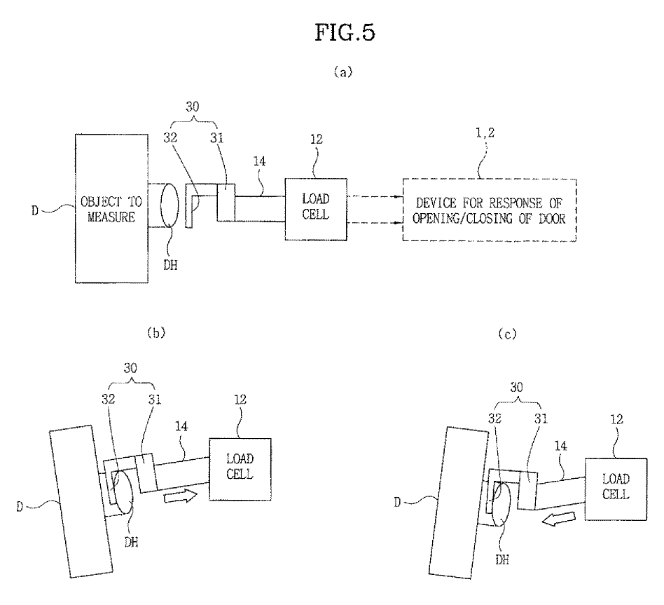

In order to measure the response of opening/closing of a door using jig 30, as shown in FIG. 5A, door handle lock 32, protruding from connecting body 31 which is attached to measurement jig connection end 15 of jig 30, is attached to outside door handle DH, and door handle fixing ends 33, which are thread-fastened to connecting body 3 are turned such that lock 322 is in contact with outside door handle DH.

As controller 1 drives upper and lower motors 4 and 9 to open and close the door using outside door handle DH, as shown in FIGS. 5B and 5C, jig 30 measures the response.

Changes in the door opening/closing force by outside door handle DH are generated when door D is unlocked from jig 30 and then opened.

Values for the door opening/closing force by jig 30 are measured by load cell 12 and transmitted to controller 1, which analyzes the changes in the door opening/closing force.

In opening/closing door D using jig 30, abnormal displacement through the hinge of door D is compensated by deformable shaft 14, either mechanically or by calculation.

To measure the operation of outside door handle DH using separate jig 40 for opening/closing a door handle, as shown in FIG. 6A, jig 40 for opening/closing a door handle is combined to measurement jig connection end 15 and to outside door handle DH. Accordingly, door handle locking body 42 of jig 40 surrounds outside door handle DH, and is secured to outside door handle DH by operating door handle fixing ends 43 thread-fastened to door handle locking body 42.

As driving motors 4 and 9 are driven by controller 1, jig 40 measures operational condition and required load of outside door handle DH by pulling outside door handle DH as shown in FIG. 6B, or obliquely pulling outside door handle DH upward, as shown in FIG. 6C.

Oblique upward pulling of outside door handle DH is caused by the structure of jig 40, that is, since jig 40 has rotary connection end 41 hinged to door handle locking body 42, rotary connection end 41 can freely pivot up and down.

Load cell 12 measures values for operation of outside door handle DH by jig 40 and controller 1 analyzes changes in the operation of outside door handle DH.

Further, in order to measure closing force of a door using a separate jig 50 for measuring the closing force of a door, as shown in FIG. 7, jig 50 is combined to the end of extending shaft 13.

Jig 50 has a bearing in bearing connection end 51 so that bearing connection end 51 rotates by ˜60° to compensate for the curve of the surface of door D, because the closing force of a door (force pushing the door by the weather strip of the door) pushes the surface of door D while being in contact.

Further, door contact end 52 of bearing connection end 51 is covered with a urethane material, such that the surface of door D is not deformed or damaged by contact.

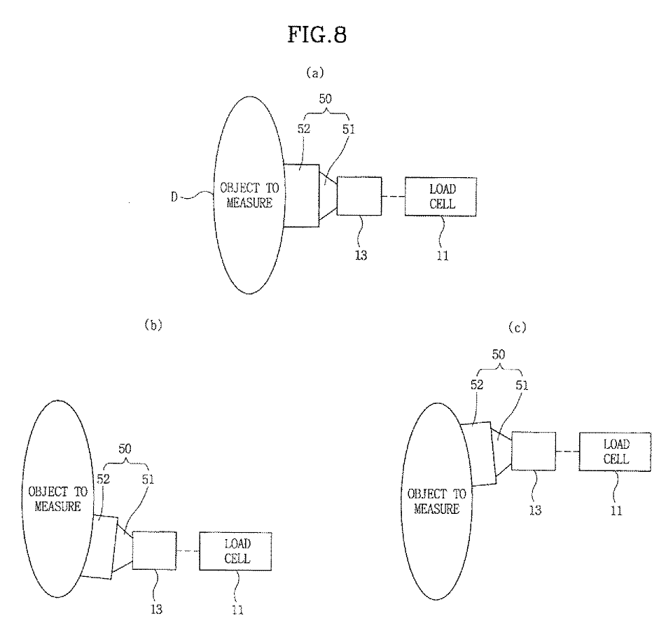

As controller 1 drives upper and lower motors 4 and 9 and jig 50 is actuated as shown in FIG. 8A, jig 50, as shown in FIGS. 8B and 8C, pushes door D in a plurality of directions through bearing connection end 51 in contact with the surface of door D.

As jig 50 pushes door D, values for the force applied to door D by the weather strip is measured by load cell 12 and transmitted to controller 1, which analyzes changes in the closing force.

As described above, according to an aspect of the invention, since the initial operation, the response of opening/closing, the operation of an outside door handle, and the closing force for the door is analyzed by the corresponding jigs for each item that are controlled by a computer, it is possible to prevent inaccuracies associated with traditional manual operation.

Further, since many properties are measured by replacing only the parts for each property, cost and usability are improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A jig assembly for measuring performance aspects of a door of a vehicle, the assembly comprising:
a controller; and
a shifting member comprising guide rails and motors, the motors being controlled by the controller to move the guide rails.
wherein the shifting member is configured such that at least one of a plurality of removable jigs can be connected thereto, each one of said jigs cooperating with the controller to measure at least one performance aspect of the door.

2. The jig assembly as defined in claim 1, further comprising:
a movable frame mounted to the shifting member;
a load cell attached to the movable frame for measuring a load applied to the door;
a first shaft extending from the load cell; and
a second, flexible shaft connected to the first shaft and configured for the jigs to be connected thereto.

3. The jig assembly as defined in claim 1, wherein the jigs comprise:
a jig for measuring operation of the door;
a jig for measuring opening and closing of the door;
a jig for measuring opening and closing of a handle of the door; and
a jig for measuring closing force of the door.

4. The jig assembly as defined in claim 1, further comprising a vacuum source, which supplies negative pressure to the jig to attach the jig to the door.

5. The jig assembly as defined in claim 3, wherein the jig for measuring opening and closing of the door comprises a door handle lock to lock the handle.

6. The jig assembly as defined in claim 3, wherein the jig for measuring opening and closing of the handle comprises a rotary connection end that is combined to the shifting member, and a door handle locking body that is hinged to the rotary connection end and attachable to the handle.

7. The jig assembly as defined in claim 3, wherein the jig for measuring the closing force of the door comprises a rotatable bearing connection end that is connected to the load cell; and a door contact end at an end of the bearing connection end, and configured to contact the door.

8. The jig assembly as defined in claim 7, wherein the bearing connection end is rotatable by approximately 60°.

9. The jig assembly as defined in claim 7, wherein the door contact end comprises urethane.
